(19) United States
(12) Patent Application Publication
(10) Pub. No.: US 2003/0154072 A1
(43) Pub. Date: Aug. 14, 2003

(54) Call analysis

(75) Inventors: Jonathan Hood Young, Newtonville, MA (US); Sean D. True, Natick, MA (US); David Meyer Ray, Somerville, MA (US); Jakob Wahlberg, Auburndale, MA (US); Bradley Ray Howes, Waltham, MA (US); Megan M. McA'nulty, Newton, MA (US); John A. Morse, Newton, MA (US); Mark Jackson, Watertown, MA (US)

Correspondence Address: FISH & RICHARDSON P.C., 1425 K STREET, N.W., 11TH FLOOR, WASHINGTON, DC, 20005-3500, US

(73) Assignee: ScanSoft, Inc., a Delaware corporation

(21) Appl. No.: 10/345,146

(22) Filed: Jan. 16, 2003

Related U.S. Application Data
(63) Continuation of application No. 09/535,155, filed on Mar. 24, 2000.
Application No. 09/535,155 is a continuation-in-part of application No. 09/052,900, filed on Mar. 31, 1998, now Pat. No. 6,112,172.

(51) Int. Cl. G06F 17/27

(52) U.S. Cl. 704/9

(57) ABSTRACT

A method of analyzing a collection of calls at one or more call center stations. The method includes receiving lexical content of a telephone call handled by a call center agent and identifying one or more features of the telephone call based on the received lexical content. The method also includes collectively analyzing the stored features along with the stored features of other telephone calls and reporting results of the analyzing.

### REFERENCE TO RELATED APPLICATION

This application relates to and is a continuation-in-part of co-pending U.S. Application No. 09/052,900, titled “INTERACTIVE SEARCHING,” which is incorporated by reference.

### BACKGROUND

This invention relates to speech recognition.

Many businesses and organizations provide call centers to handle phone calls with customers. Typically, call centers employ multiple agents to handle technical support calls, customer orders, and so forth. Call centers often provide scripts and other techniques to ensure that calls are handled consistently and in the manner desired by the organization. Some organizations record telephone conversations between agents and customers to monitor customer service quality, for legal purposes, and for other reasons. Sometimes, organizations also record calls within an organization such as one call center agent asking a question of another agent.

Buried within the collection of recorded calls from a call center are customer comments, suggestions, and other information of interest in making decisions regarding marketing, technical support, engineering, call center management, and other issues. In an attempt to harvest information from this direct contact with customers, many centers instruct agents to ask specific questions of customers and to log their responses into a database.

### SUMMARY

In general, in one aspect, the invention features a method of analyzing a collection of calls at one or more call center stations. The method includes receiving lexical content of a telephone call handled by a call center agent, the lexical content being identified by a speech recognition system and identifying one or more features of the telephone call based on the received lexical content. The method also includes storing the one or more identified features along with one or more identified features of another telephone call, collectively analyzing the stored features of the telephone calls, and reporting results of the analyzing.

Embodiments may include one or more of the following features. The method may include receiving acoustic data signals corresponding to the telephone call, and

performing speech recognition on the received acoustic data to determine the lexical content of the call. The method may include receiving descriptive information for a call such as the call duration, call time, caller identification, and agent identification. Identifying features may be performed based on the descriptive information.

One or the features may include a term frequency feature, a readability feature, a script-adherence feature, and/or feature classifying utterances (e.g., classifying an utterance as at least one of the following: a question, an answer, and a hesitation).

The method may further include receiving identification of a speaker of identified lexical content. The identification may be determined. The features may include a feature measuring agent speaking time, a feature measuring caller speaking time.

The analysis may include representing at least some of the calls in a vector space model. The analysis may further include determining clusters of calls in the vector space model, for example, using k-means clustering. The analysis may further include tracking clusters of calls over time (e.g., identifying new clusters and/or identifying changes in a cluster). The analysis may further include using the vector space model to identify calls similar to a call having specified properties, for example, to identify calls similar to a specified call. The analyzing may include receiving an ad-hoc query (e.g., a Boolean query) and ranking calls based on the query. Such a ranking may include determining the term frequency of terms in call and/or determining the term frequency of terms in a corpus of calls and using an inverse document frequency statistic.

The collectively analyzing may include using a natural language processing technique. The method may include storing audio signal data for at least some of the calls for subsequent playback. The collectively analyzing may include identifying call topics handled by call center agents and/or determining the performance of call center agents.

In general, in another aspect, the invention features software disposed on a computer readable medium, for use at a call center having one or more agents handling calls at one or more call center stations. The software includes instructions for causing a processor to receive lexical content of a telephone call handled by a call center agent, the lexical content being identified by a speech recognition system, identify one or more features of the telephone call based on the received lexical content, store the identified features along with the identified features of other telephone calls, collectively analyze the features of telephone calls, and report the analysis.

Other features and advantages of the invention will be apparent from the following description, including the drawings, and the claims.

### BRIEF DESCRIPTION OF THE DRAWINGS

FIG. 1 is a diagram of a call center that uses speech recognition to identify terms spoken during calls between agents and customers.

FIG. 2 is a flowchart of a process for identifying call features and using the identified features to generate reports and to respond to queries.

FIG. 3 is a flowchart of a process for identifying call features.

FIG. 4 is a diagram of a vector space having call features as dimensions.

FIG. 5 is a diagram of clusters in vector space.

FIG. 6 is a flowchart of a process for using a vector space representation of calls to produce reports and respond to queries.

### DETAILED DESCRIPTION

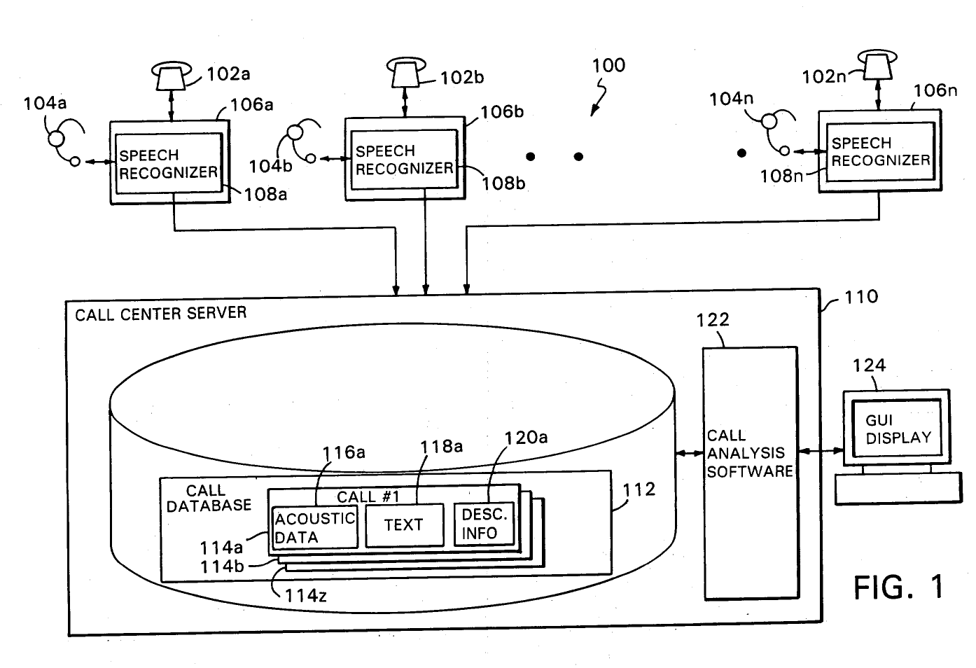

FIG. 1 shows an example of a call center 100 that enables a team of phone agents to handle calls to and from customers. The center 100 uses speech recognition systems 108a-108n to automatically “transcribe” agent/customer conversations. Call analysis software 122 analyzes the transcriptions generated by the speech recognition systems to identify different features of each call. For example, the software 122 can identify the topics discussed between an agent and a customer and can gauge how well the agent handled the call. The software 122 can also perform statistical analysis of these features to produce reports identifying trends and anomalies. The system 100 enables call managers to gather important information from each dialog with a customer. For example, by constructing queries and reviewing statistical reports of the calls, a call manager can identify product or documentation weaknesses and agents needing additional training.

Sample Architecture

In greater detail, FIG. 1 shows call center stations 106a-106n (e.g., personal computers in a PBX (Private Branch Exchange)) receiving voice signals from both customer phones 102a-102n and agent headsets 104a-104n. Instead of acting as simple conduits between agents and customers, the stations 106a-106n record the acoustic signals of each call, for example, as PC “.wav” sound files. Speech recognition systems 108a-108n, such as NaturallySpeaking™4.0 from Dragon Systems™ of Newton, Mass., process the sound files to identify each call's lexical content (e.g., words, phrases, and other vocalizations such as “um” and “er”). When possible, the speech recognition systems 108a-108n use trained speaker models (i.e., models tailored to the speech of a particular speaker) to improve recognition performance. For example, when a system 108a-108n can identify an agent (e.g., from the station used) or a customer (e.g., using caller ID or a product license number), the system 108a-108n may load a speech model previously trained for the identified speaker.

The stations 106a-106n send the acoustic signals 116 and the lexical content 118 of each call 114 to a server 110. The server 110 stores this information in a database 112 for analysis and future retrieval. The server 110 also may receive descriptive information 120 for each call, such as agent comments entered at the station, the time of day of the call, the identification of the agent handling the call, and the identification of the customer (e.g., the customer's name from caller ID or the customer's product license number). The server 110 can request the descriptive information, for example, through an API (application programming interface) provided by the stations 106a-106n or by a centralized call switching system.

As shown, a call manager's computer 124 provides a graphical user interface that enables the manager to construct and submit queries, view the response of the software 122 to such queries, and view other reports generated by the software 122.

Another call center may have an architecture substantially different from that of the call center 100 shown in FIG. 1. For example, instead of distributing speech recognition systems 106a-106n over the call center stations 106a-106n, the server 110 could perform some or all of the speech recognition. Additionally, call analysis software 122 need not reside on the call server 110, but may instead reside on the client.

Call Processing

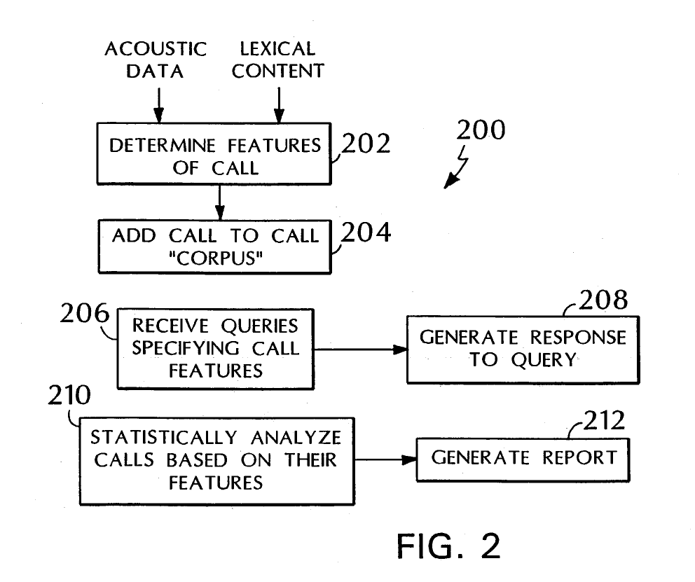

FIG. 2 shows a process 200 for analyzing a collection of calls such as calls collected at the call center shown in FIG. 1. These techniques are not limited to the handling of call center conversations, but instead can be used to analyze recorded telephone conversations regardless of their origin. For example, the techniques can analyze financial conference calls, interviews (conducted, for example, by a remote medical advisor, a market researcher, or a journalist), 911 calls, and lawyer-client conversations.

As shown, the process 200 receives the acoustic signals of a call and the results of speech recognition (e.g., the lexical content). Speech recognition can produce a list of identified terms (e.g., words and/or phrases), when the term was spoken (e.g., start and end time offsets into the sound file), and the speech recognition system's confidence 206 in the system's identification of the term. The system may also list the speaker of each term.

A number of hardware and software techniques can be used to identify a speaker. For example, some call center stations provide one output for an agent's voice and another for a customer's voice. In such cases, identifying the speaker is a simple matter of identifying the output carrying the speech. In other configurations, such as those that only provide a single output with the combined voices of agent and customer, hardware and/or software can separate agent and customer voices. For example, a feed-forward loop can subtract the signal from the agent's headset microphone from the signal of the agent's and customer's voice combined, leaving only the signal of the customer's voice. In other embodiments, the speaker 208 of a term can be determined using software speaker identification techniques.

From the acoustic signals and lexical content, the process 200 can identify different call features (step 202). For example, the process 200 can score each call for the presence of any of a list of profane word spoken by the agent and/or customer. A number of other features are described below.

After determining features, the process 200 adds the call features to the corpus (entire collection) of calls previously processed (step 204). Thereafter, the process 200 can receive user queries specifying Boolean or SQL (Structure Query Language) combinations of features (step 206) and can respond to these queries with matches or near matches (step 208). For example, a call manager may look for heated conversations caused by a customer's being on hold too long with an SQL query of “select*from CallFeatures where ((CustomerProfanity>3) and (HoldDuration>1:00)).” To speed query responses, the process may construct an inverted index (not shown) listing features and the different calls having those features.

Many times ad-hoc queries return either too few or too many calls. Thus, software may use more sophisticated techniques to rank query results. To this end, the software may maintain statistics on the entire collection of calls. For example, the software may maintain the document frequency (df) of terms (e.g., the number of calls including a particular term). A less evenly distributed word (e.g., a term appearing in fewer calls) may be more telling of call content. That is, the word “try” may appear in many calls, but the term “transducer” may appear in a handful of calls. Thus, calls having query terms with lower df values may provide a more telling indication of the call's subject matter and may be ranked higher than other calls listed in response to a query.

The software can also track the proximity of terms. That is, some collections of terms have flexible but significant relationships. For example, “knock” and “door” often appear close to one another, but not necessarily one right after the other. The software can track the mean (μ) number of terms separating “door” and “knock” along with a standard deviation (σ). Calls having these terms separated by the mean number of words plus or minus a standard deviation are likely to correspond to a query for those terms and may be ranked more highly in a list of calls provided in response to a query. Thus, a query for “knock door” may return a list of calls where calls having the phrase “knock on the door” may be ranked more highly than “a knock indicates that the hotel maid is at your door”.

In addition to Boolean, SQL, and other ad-hoc queries, the process 200 may analyze call features using more sophisticated statistical approaches (step 210). This enables the software to generate reports (step 212) characterizing the distributions of calls and permits even more abstract queries (e.g., “find calls like this one”).

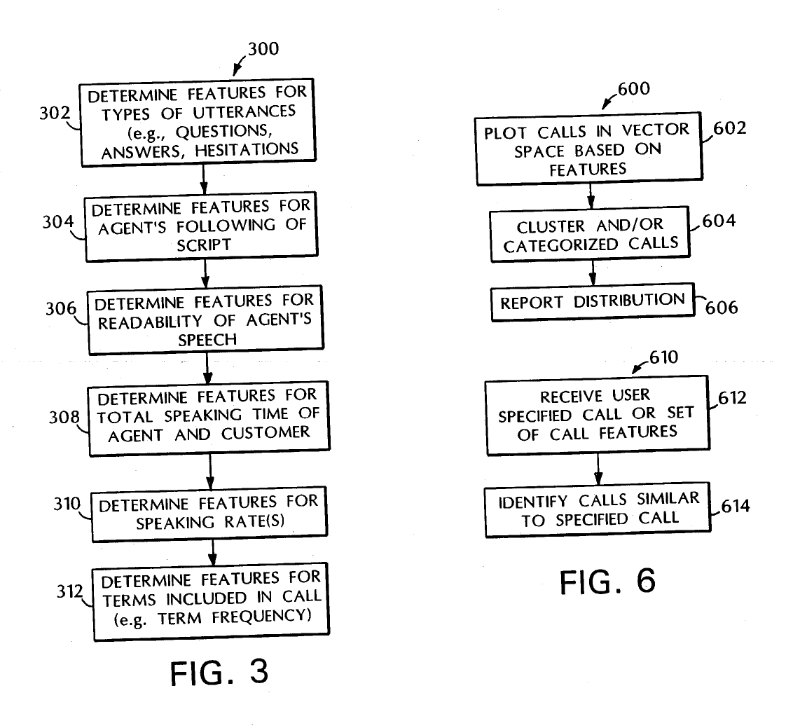

FIG. 3 shows a process 300 for identifying different features of a call. As shown, portions of a call may be analyzed to determine whether the portion corresponds to a question, answer, or hesitation (step 302). The number of questions, answers, and/or hesitations spoken by an agent and/or customer can form a score or scores for analysis. Such scores can help call center managers identify agents who may not be fully up to speed on a particular matter. For example, agents needing additional training may exhibit hesitation or ask more questions than other agents. Speech may be categorized using analysis of acoustic signals and/or the corresponding lexical content. For example, analysis of the intonation (e.g., fundamental frequency) of each utterance can indicate the type of utterance. That is, in English, questions tend to end with a rising intonation, statements tend to end with falling intonations, and hesitations tend toward a monotone.

Analysis of the lexical content of the call may also be used to classify call portions. For example, most questions begin with a limited number of characteristic terms. That is, many questions begin with “are”, “why”, or “how,” while phrases such as “hold on” or vocalizations such as “um” and “er” characterize hesitations.

The process 300 can also determine a score for a call feature that measures the correspondence of the agent's speech with the provided script (step 304). That is, the process 300 can determine for each agent utterance, whether it follows the logical pattern of a previously specified script. For example, the system might determine how closely an agent followed a script, whether the agent repeated questions, backed up, or whether portions of the script were skipped in this call. Sophisticated systems might include scripts that fork and rejoin. The score may be adjusted to be more or less tolerant of deviations from the script.

Since call centers such as technical support lines often receive calls from befuddled consumers, the process 300 may determine a “readability” score for the agent's speech (step 306) to ensure agents do not overwhelm such callers with technical jargon. Typically, readability formulas readability scores based on the measures such as the number of syllables per word, the number of words per sentence, and/or the number of letters per work. For example, the “Kincaid” score can be computed as: {[11.8*(syllables per word)]+[0.39*(words per sentence)]}. Other scores include the Automated Readability Index, the Coleman-Liau score, the Flesch Index, and the Fog Index.

The process 300 may also determine other features such as the total speaking time by the agent and the customer (step 308). Similarly, the process 300 may determine the speaking rate (e.g., syllables per second) (step 310). These features may be used, for example, to identify agents spending too much time on some calls or hurrying through others. The process also may derive features from combinations of other features. For example, a “Bad Call” score may be determined by (Profanity Score/Duration of Call).

The process 300 may also identify features based on the number of occurrences of terms in a call (step 312). For example, the process 300 may count the number of times a product name is spoken during a call.

Call Clustering

Any of the features described above may be the basis of an ad-hoc query or other statistical analysis such as categorization and/or clustering. Categorization sorts calls into different predefined bins based on the features of the calls. For example, call categories can include “Regarding product X”, “Simple Broker Purchase or Sale”, “Request for literature”, “Machine misconfigured”, and “Customer Unhappy.” By contrast, clustering does not make assumptions about call categories, but instead lets calls clump into groups by natural divisions in their feature values. Both clustering and categorization can use a “vector space model” to group calls.

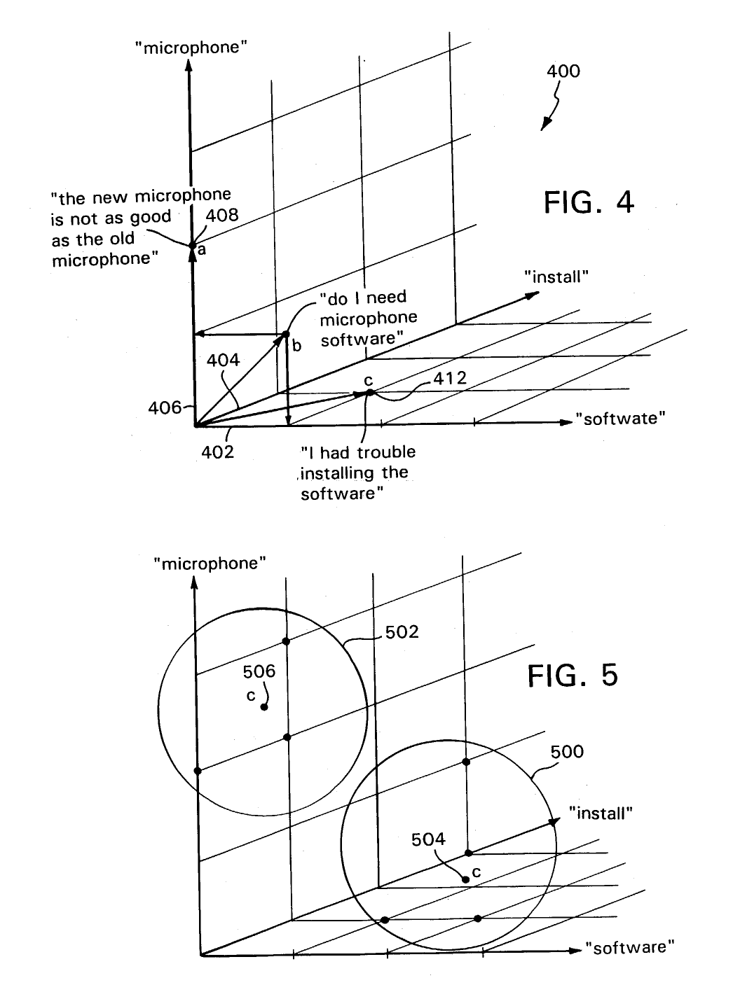

FIG. 4 shows a very simple vector space 400 having three-dimensions 402, 404, 406. Each dimension 402, 404, 406 represents a feature of a call. For example, as shown, the x-axis 402 measures the number of times a customer says “software”; the y-axis 406 measures the number of times the customer says “microphone”; and the z-axis 404 measures the number of times a customer says “install.” Using these features as coordinate system 400 dimensions, 402, 404, 406, each call, whether ten-minutes or ten-seconds long, can be plotted as a single point (or vector) in the space 400 by merely counting up the number of times the selected words were spoken. For example, point 408 corresponds to a call where a customer said “the new microphone is not as good as the old microphone.” Since the word “microphone” was spoken twice and the words “install” and “software” were not spoken at all, the call has coordinates of (0, 2, 0).

FIG. 4 shows a three-dimensional vector space. Although difficult to imagine, the vector space is not limited to three-dimensions, but can instead have n-dimensions where n is the number of different features of a call. A call manager can control the number of dimensions, for example, by configuring the statistical analysis system to focus on certain features, words, or sets of words (e.g., profanity, product names, and/or words associated with common problems).

In other implementations, the n may be the number of different words in the English language. A variety of techniques can reduce the large number of dimensions without greatly affecting the call's content. For example, stemming reduces the number of dimensions by truncating words to common roots. That is, “laughing”, “laughs”, and “laughter” may all truncate to “laugh”, reducing the number of dimensions by three. A “stop list” of common words such as articles and prepositions can also significantly reduce the number of dimensions representing call content. Additionally, synonym-sets can reduce dimensions by providing a single dimension for terms with similar meanings. For example, “headphones”, “headset”, or “mic” are all synonyms with “microphone.” Thus, a system can eliminate dimensions by counting appearance of “headphones”, “headset”, “mic” as appearances of “microphone”.

The description, thus far, used the number of times a term (e.g., a word or a phrase) was spoken in a call as the value of that term's feature. This measure is known as a term's frequency (tf). The term frequency roughly gauges how salient a word is within a call. The higher the term frequency, the more likely it is that the term is a good description of the document content. Term frequency is usually dampened by a function (e.g., \sqrt{tf}) since occurrence indicates a higher importance, but not as important as a strict count may imply. Additionally, the term frequency statistic can reflect the confidences of the speech recognition system for each term to reflect uncertainty in identification during recognition. For example, instead of adding up the number of times a term appears in lexical content, a process can sum the speech recognition systems confidences in each term.

Quantification of term features (“weighting”) can be improved using document frequency statistics. For example, idf (inverse document frequency) expressions, combine tf values of a call with df (document frequency) values. For example, the feature value for a word may be computed using:

Weight=(1+log(tf_{word}))log(NumDocs/df_{word}).

Such an expression embodies the notion that a sliding scale exists between term frequency within a document and the term's comparative rareness in a corpus.

Plotting calls in vector space enables quick mathematical comparison of the calls. For example, the angle formed by two “call” vectors is also a good estimate of topical similarity. That is, the smaller the angle the more similar the calls. Alternatively, the geometric distance between vector space points may provide an indication of topical similarity.

These simple quantifications of similarity can ease call retrieval and provide insight into call content. For example, instead of constructing a query, a call manager can request all calls resembling a specified call. In response, analysis software can plot the specified call and rank similar calls based on their distance from the specified call. Alternatively, by providing “seed category” points in the vector space, software can categorize calls based on their proximity to a particular seed. For example, different seeds may correspond to different products.

As shown in FIG. 5, over time, call “points” populate the vector space. By visual examination, these points seem to form groups 500, 502 of related calls. That is, group 500 seems to correspond to calls discussing microphone problems, while group 505 seems to correspond to calls discussing software installation problems. As shown, each group 500, 502 has a “centroid”, C, 504, 506. Each centroid 504, 506 is the “center of gravity” of its respective cluster. The centroid 504, 506 may not correspond to a particular call. However, each group 500, 502 also has a medoid, a “prototypical” group member that is closest to the centroid.

A wide variety of clustering algorithms can partition the points into groups 500, 502. For example, the K-means clustering algorithm begins with an initial set of cluster points. Each point is assigned to the nearest cluster center. The algorithm then re-computes cluster centers by re-determining cluster centroids. Each point is then reassigned to the nearest cluster center and cluster centers are recomputed. Iterations can continue as long as each iteration improves some measure of cluster quality (e.g., average distance of cluster points to their cluster centroids).

More generally, clustering algorithms include “bottom-up” algorithms that form partitions by starting with individual points and grouping the most similar ones (e.g., those closest together) and “top-down” algorithms that form partitions by starting with all the points and dividing them into groups. Many clustering algorithms may produce different numbers of clusters for different sets of points, depending on their distribution in the vector space.

Tracking the number of clusters over time can provide valuable information to a call manager. For example, dissipation of a “microphone” problem cluster may indicate that a revision to a manual addressed the problem. Similarly, a “software installation” cluster may emerge when upgrades are distributed. The software can monitor the number of points in a cluster over time. When a new cluster appears, the software may automatically notify a manager, for example, by sending e-mail including an “audio bookmark” to the cluster's medoid call.

Though the running example in FIGS. 4 and 5 used terms such as vector space dimensions, any call feature (e.g., one of those shown in FIG. 3) may be used as a hyperdimension axis. For example, in addition to term frequencies, a vector space may include a time-of-day feature. This may show that certain problems prompt calls during the workday while others prompt calls at night.

FIG. 6 shows processes 600, 610 that implement some of the capabilities described above. For example, process 600 may plot each call in vector space based on the respective call features (step 602). The process 600 may, in turn, form clusters or categorize the calls based on their vector space coordinates (step 604). From the clusters and/or categorizations, the process 600 can generate a report (step 606) identifying call grouping properties, size, and development over time. As shown, another process 610 can use the vector space representation of a collection of calls to provide a “query-by-example” capability. For example, the process may receive a description of a point in vector space (step 612), for example, by user specification of a particular call, and may then identify calls similar to the specified call (step 614).

Process 600 may provide a user interface that enables a call center manager to configure call analysis and to prepare and submit queries. For example, the user interface can enable a manager to identify different call categories and characteristics of these categories (e.g., a Boolean expression that is “True” when a call falls in a particular category or a vector space location corresponding to the category). The user interface and analysis software may enable a manager to limit searches to calls belonging to a cluster or category or having a particular feature (e.g., only calls about product X handled by a particular agent). The user interface may also present a ranked list of calls or categories corresponding to a query, generate statistical reports, permit navigation to individual calls, enable users to listen to individual calls, search for keywords within the calls, and customize the set of statistical reports

Embodiments

Though this application described conversations between agents and customers at a call center, the described techniques may be applied to calls of any origin. The techniques are not limited to any particular hardware or software configuration; they may find applicability in any computing or processing environment. The techniques may be implemented in hardware or software, or a combination of the two. Preferably, the techniques are implemented in computer programs executing on programmable computers that each include a processor, a storage medium readable by the processor (including volatile and non-volatile memory and/or storage elements), at least one input device, and one or more output devices. Program code is applied to data entered using the input device to perform the functions described and to generate output information. The output information is applied to one or more output devices.

Each program is preferably implemented in a high level procedural or object oriented programming language to communicate with a computer system. However, the programs can be implemented in assembly or machine language, if desired. In any case, the language may be a compiled or interpreted language.

Each such computer program is preferable stored on a storage medium or device (e.g., CD-ROM, hard disk or magnetic diskette) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.

Other embodiments are within the scope of the following claims.

What is claimed is:

1. A method of analyzing a collection of calls at one or more call center stations, the method comprising:
receiving lexical content of a telephone call handled by a call center agent, the lexical content being identified by a speech recognition system;
identifying one or more features of the telephone call based on the received lexical content;
storing the one or more identified features along with one or more identified features of another telephone call;
collectively analyzing the stored features of the telephone calls; and
reporting results of the analyzing.

2. The method of claim 1, further comprising
receiving acoustic data signals corresponding to the telephone call, and
performing speech recognition on the received acoustic data to determine the lexical content of the call.

3. The method of claim 1, further comprising receiving descriptive information for a call.

4. The method of claim 3, wherein the descriptive information comprises at least one of the following: call duration, call time, caller identification, and agent identification.

5. The method of claim 3, wherein identifying features comprises identifying features based on the descriptive information.

6. The method of claim 1, wherein lexical content comprises words.

7. The method of claim 1, wherein one of the one or more features comprises at least one term frequency feature.

8. The method of claim 1, wherein one of the one or more features comprises a readability feature.

9. The method of claim 1, wherein one of the one or more features comprises a feature classifying utterances.

10. The method of claim 9, wherein classifying utterances comprises classifying an utterance as at least one of the following: a question, an answer, and a hesitation.

11. The method of claim 1, wherein one of the one or more features comprises a feature representing the agent's adherence to a script.

12. The method of claim 1, further comprising receiving identification of a speaker of identified lexical content.

13. The method of claim 12, further comprising identifying a speaker of identified lexical content.

14. The method of claim 12, wherein one of the one or more features comprises a feature measuring agent speaking time.

15. The method of claim 12, wherein one of the one or more features comprises a feature measuring caller speaking time.

16. The method of claim 1, wherein analysis comprises representing at least some of the calls in a vector space model.

17. The method of claim 16, further comprising determining clusters of calls in the vector space model.

18. The method of claim 16, wherein determining clusters comprises k-means clustering.

19. The method of claim 16, further comprising tracking clusters of calls over time.

20. The method of claim 19, wherein tracking comprises identifying new clusters.

21. The method of claim 19, wherein tracking comprises identifying changes in a cluster.

22. The method of claim 16, further comprising using the vector space model to identify calls similar to a call having specified properties.

23. The method of claim 16, further comprising using the vector space model to identify calls similar to a specified call.

24. The method of claim 1, wherein collectively analyzing comprises receiving an ad-hoc query and ranking calls based on the query.

25. The method of claim 24, wherein the query comprises a boolean query.

26. The method of claim 24, wherein ranking comprises determining the term frequency of terms in call.

27. The method of claim 26, wherein ranking comprises determining the term frequency of terms in a corpus of calls and using an inverse document frequency statistic.

28. The method of claim 1, wherein collectively analyzing comprises analyzing using a natural language processing technique.

29. The method of claim 1, further comprising storing audio signal data for at least some of the calls.

30. The method of claim 29, wherein reporting comprises providing the audio signal data for playback.

31. The method of claim 1, wherein collectively analyzing comprises identifying call topics handled by call center agents.

32. The method of claim 1, wherein collectively analyzing comprises determining the performance of call center agents.

33. Software disposed on a computer readable medium, for use at a call center having one or more agents handling calls at one or more call center stations, the software including instructions for causing a processor to:
receive lexical content of a telephone call handled by a call center agent, the lexical content being identified by a speech recognition system;
identify one or more features of the telephone call based on the received lexical content;
store the identified features along with the identified features of other telephone calls;
collectively analyze the features of telephone calls; and
report the analysis.
